(19) United States
(12) Patent Application Publication
(10) Pub. No.: US 2010/0316970 A1
(43) Pub. Date: Dec. 16, 2010

(54) Implant root for tooth implanting

(76) Inventors: Jeng-Kang Richard Shih, San Diego, CA (US); Geoffrey How-Ting Shih, San Diego, CA (US)

Correspondence Address: J. RICHARD SHIH (JENG-KANG RICHARD SHIH), 14616 LA PLATA, SAN DIEGO, CA, 92127, US

(21) Appl. No.: 12/799,691

(22) Filed: Jun. 10, 2009

(51) Int. Cl. A61C 8/00

(52) U.S. Cl. 433/174

(57) ABSTRACT

An improved implant root for tooth implanting into the alveolar bone of a patient, said implant root comprises: a coarse threaded portion of the implant root is formed to have a wider base and to have an extension root with various radiant thread constructed, characterized with a circumferential constricted neck between these two segments. Both segments are designed to be seated into alveolar bone as implant root fixture. The widest diameter of the upper and lower segment is either equal or the lower base is slightly wider than lower segment for the most of it. The constricted neck in between the base and extension of the segments and the shape of the lower base segment allow the lower base implant root to serve as a primary stability anchor. Combining the concept of wider base with extensions allow the base segment of the implant fixture becomes a physiological anchor healed in bone and to increase the stability of the implant around the implant fixture after bone heal thus advantage the implant to be placed in some type of bones needing this kind of anchorage.

The present invention relates to an implant root device.

### BACKGROUND OF THE INVENTION

1. Field of the Invention

The present invention relates to an improved implant root form for tooth implanting, and especially to an implant root of which has a circumferential constricted neck portion which is allowed bone to grow into the space of concavity and increases the surface of bone contact as well as the ability to allow one implant root has varies diameters constructed. Thus this larger diameter lower base implant segment assembly provides anchorage and allows shorter length of implant can be placed, as well as the ability to change final implant inserting angle because of upper extension segment is narrower than the base segment.

2. Description of the Prior Art

The history of the technique of tooth implanting in an oral cavity has been several decades of years; the technique mainly has a tooth form Titanium alloy root to replace the missing tooth and then restore the upper part of the root. The tooth implanting work is completed when the implant root is covered with a crown. Although it has been known for century that a tooth with curved or bulged root (for example: tooth root Cementosis) extraction is always a challenge to oral surgeon because of its larger root trunk end. The larger base of implant root will provide the anchorage to improve implant long term stability. Although either straight or tapered root form implant fixture has been used for years and not much has changed until this invention because the root form design is usually followed the drill design and their shape. Not until recently, the immediate placement protocol established and surgeons started to perform the implant placement at the time of tooth extraction while the extraction sockets usually are larger than the preparation hole of the implant placement became a routine. Several articles revealed the success rate of immediate loading dental implant is surprisingly close to or equivalent to traditional delayed implant placement. This finding initiated the invention of this improved implant root design. The advantage of the work is to provide a wider base of implant root with one or two pieces construction ability. The active and aggressive implant root end is intended to provide initial stability of the implant placement. The covering screw that covered the top extension segment of the implant root is also worked as membrane stabilizer. Although primary stability of present invention might be able to be achieved by longer base segment, the present invention is designed to be worked with bone grafting and current immediate loading protocol already published.

FIG. 1 shows an implant root habitually used presently; basically, the implant root is made of pure titanium or titanium alloy, it has on its upper area a connecting portion to connect with an abutment of the crown, and has on its lower area a sharp threaded portion . A horizontal treated surface is provided between the connecting portion and the threaded portion; the treated surface is covered with hydroxyapatite similar to the material of human bone with the component of Ca.sub.10(PO.sub.4).sub.6(OH.sub.2), also called as HA coating; the treated surface 93 has a function to combine with a growing bone, so that after implanting of the implant root into a denture base, the lower base implant root segment can be firmly embedded in the prepared alveolar socket when the growth of the bone is completed, then the crown can be mounted.

With the structure of the implant root, the treated area of the HA coating is small, its ability of helping growth of the bone is inferior, the implant root being implanted is less firm, and improvement is wanted.

Further, a U.S. Pat. No. 5,588,838 disclosed a fixture, for use in a dental implant system of the type having an upper portion with a conically flaring outer surface. The conically flaring outer surface is provided with a circumferentially oriented, defined micro-roughness, preferably in the form of threads or beads, having a height between 0.02 and 0.20 mm, and most preferably approximately 0.1 mm. In the preferred embodiment, the distance between adjacent threads or beads, crest to crest, is approximately twice the height of the threads or beads, respectively. In FIGS. 1 and 2 thereof, it also disclosed that “The cutting edges and the chip-collecting cavities will allow the screw, if necessary, to function as a self-tapping screw for cutting new threads or adjusting already cut threads in the tissue.” However, the sectional areas of the chip-collecting cavities therein are very small, and have not been treated to be roughened, and the space of the tissue of the growing bone is limited, this means that the capability of fixing of the implant root is limited too.

### SUMMARY OF THE INVENTION

The present invention is an improvement on the traditional design based on the clinical success of immediate load dental implant protocol, and it can be constructed to one or two pieces design, The present invention presented a constricted neck area allows bone to heal into the concavity and increase the stability of the dental implant. The lower segment of the implant body is cylinder shape with at least two aggressive threads and the upper extension segment composed at lease one aggressive thread. The design has used wider base and its constricted neck to increase the surface of the dental implant and the stability of the implant in favor of the osteointergration of the implant.

The roughening treating process in the present invention treats with Titanium roughening treatment, preferably sand-blasting and in addition of hydroxyapitite coating.

The improved implant root provided in the present invention can have the cutting force for implanting the implant root increased during implanting of the implant root into the alveolar ridge by extending in the vertical direction of helical treated surfaces of the coarse threaded portion, and the bone dusts in the alveolar bone will stay in the treated surfaces, thereby the implant root can be smoothly inserted in the bone.

The cut faces on the helical treated surfaces of the improved implant root provided in the present invention can be plane or recessed arciform surfaces or helical surfaces; this further increases the areas of the treated surfaces and the space for staying of the bone dusts.

According to the present invention, the helical treated surfaces can be two or three surfaces laid out in an equiangularly spaced away mode, all the surfaces extend in the vertical direction as the implant root does.

The present invention will be apparent in its structure and its way of using after reading the detailed description of the preferred embodiment thereof in reference to the accompanying drawings.

### BRIEF DESCRIPTION OF THE DRAWINGS

FIG. 1 is a perspective view showing the appearance of a conventional implant root;

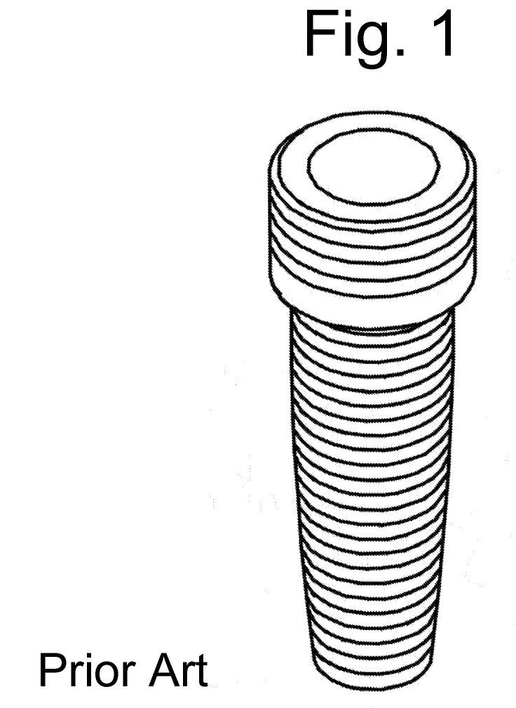

FIG. 2 is a perspective view showing the appearance of the embodiment of the present invention;

FIG. 3 is a sectional view taken from an A-A sectional line in FIG. 2; see from bottom view.

FIG. 4 is a sectional view taken from FIG. 2 showing its front side of the preferred embodiment of the present invention with an abutment connected;

FIG. 5 is an exploded perspective view from FIG. 2 showing one-piece construction of current improved implant root.

FIG. 6 is a sectional view showing two-piece construction of current improved implant root.

FIG. 7 is an exploded perspective view showing two-piece construction of current improved implant root.

FIG. 8 is an exploded perspective showing the appearance of the collagen coated root of the present invention.

FIG. 9 is a sectional view showing the appearance of the bio-resolvable material coating of the present invention.

FIG. 10 is a schematic sectional view showing implanting of an implant root of the present invention and bone grafting membrane.

### DETAILED DESCRIPTION OF THE PREFERRED EMBODIMENT

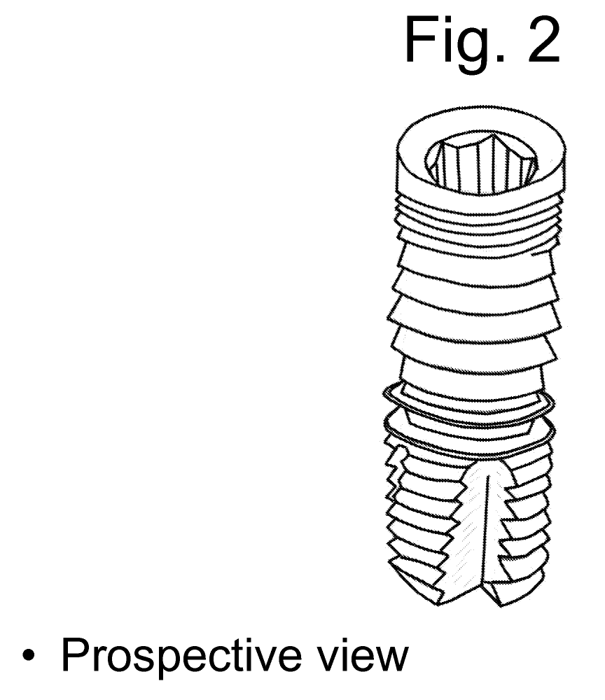

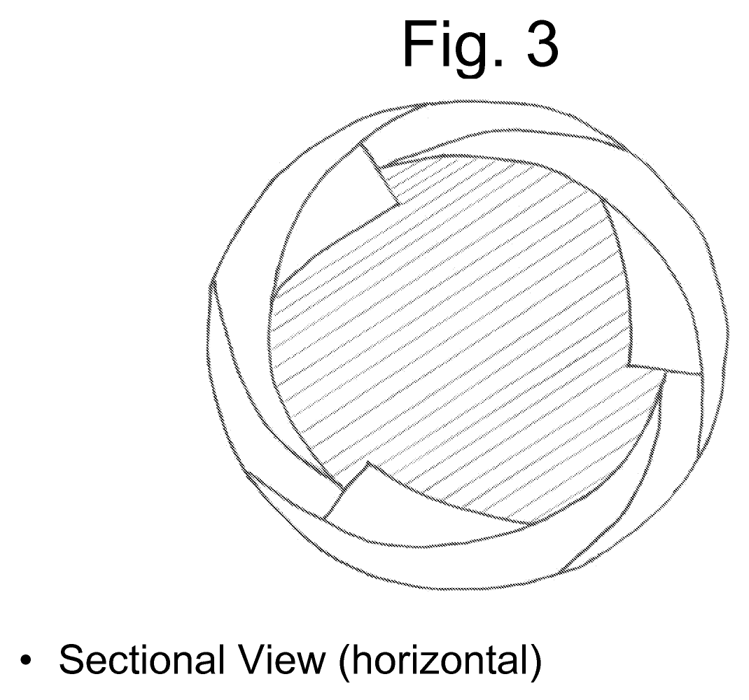

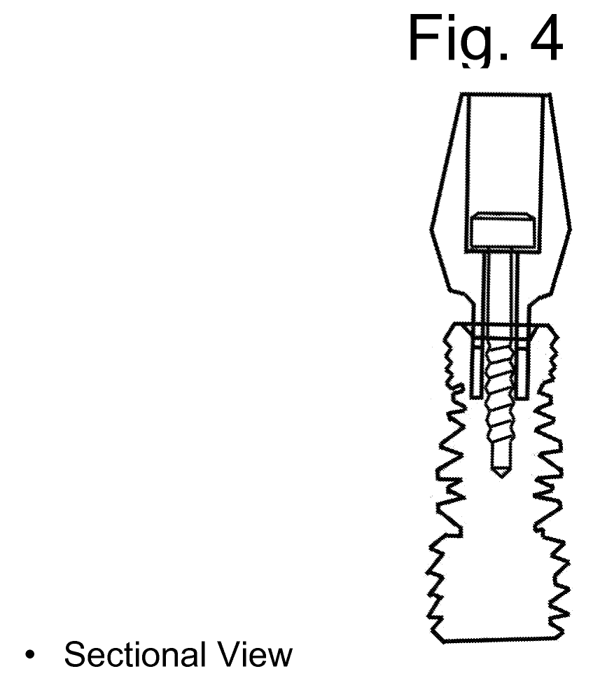

Referring to FIGS. 2 and 3 showing the first embodiment of the present invention, wherein an implant root 10 has on its upper area a connecting portion 11, the connecting portion 11 has on its outer surface a fine threaded portion, and the implant root 10 has on its lower area a coarse threaded portion 13. The connecting portion 11 is connected with an abutment 6 of a crown such as is shown in FIG. 4; the surfaces of the coarse threaded portion 13 have sharp threads that can be implanted in a denture base of a patient by rotation. Two helical treated surfaces 14 (on which cut faces are plane surfaces) formed on the coarse threaded portion 13 extending in the vertical direction are treated with roughened coatings, for example, covered with hydroxyapatite coatings, and the helical treated surfaces 14 extend in the whole length of the coarse threaded portion. Thereby the areas of the roughened helical treated surfaces 14 are larger than the area of the conventional horizontal treated surface 92, and thereby the bone of the denture base can get fast growth to envelop the implant root 10; further by combining of the roughened helical treated surfaces 14 extending in the vertical direction, firmness of the implant root 10 implanting into the denture base can be increased, and the time for waiting for mounting the crown can be reduced. And further, by extending in the vertical direction of the helical treated surfaces 13 of the coarse threaded portion 13, during implanting the implant root 10 in the denture base, the bone dusts in the denture base will stay in the helical treated surfaces 14, thereby the implant root 10 can be smoothly inserted in the bone.

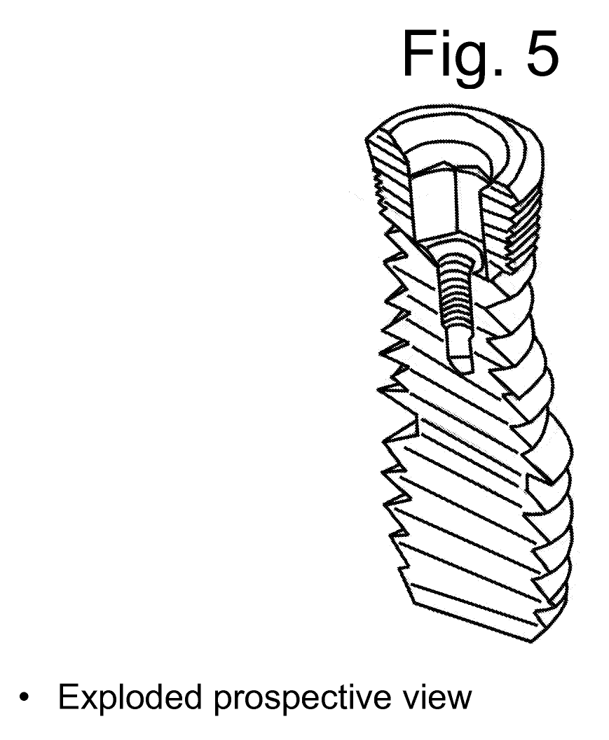

Referring to FIGS. 4 and 5, the connecting portion 11 is provided with a polygonal hole 14, a screw hole 15 is provided in the bottom surface of the polygonal hole 14. Wherein the polygonal shape of the polygonal hole 14 is mated with the shape of a connecting section 61 of the abutment 6, so that the abutment 6 can be fast and correctly positioned when in connecting with the implant root 10, and a bolt 62 on the bottom of the abutment 6 can be smoothly rotated to connect into the screw hole 15 of the implant root 10, and thus connection is completed. If incorrect positioning is resulted, the bolt 62 will be too short to be locked in the screw hole 15; thereby the situation of incorrect positioning can be completely prevented.

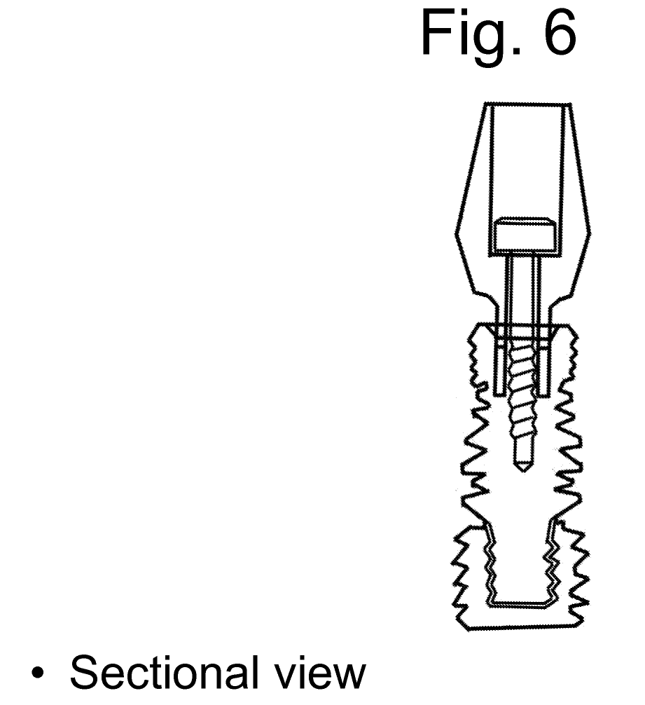

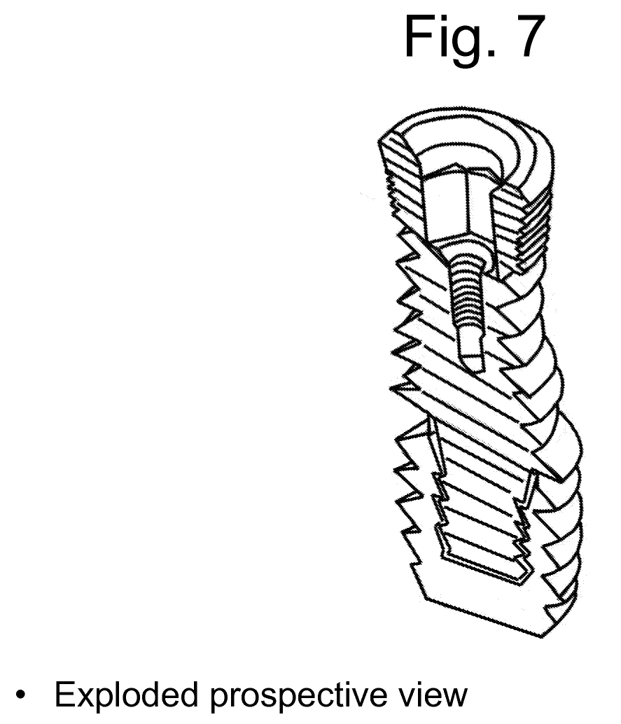

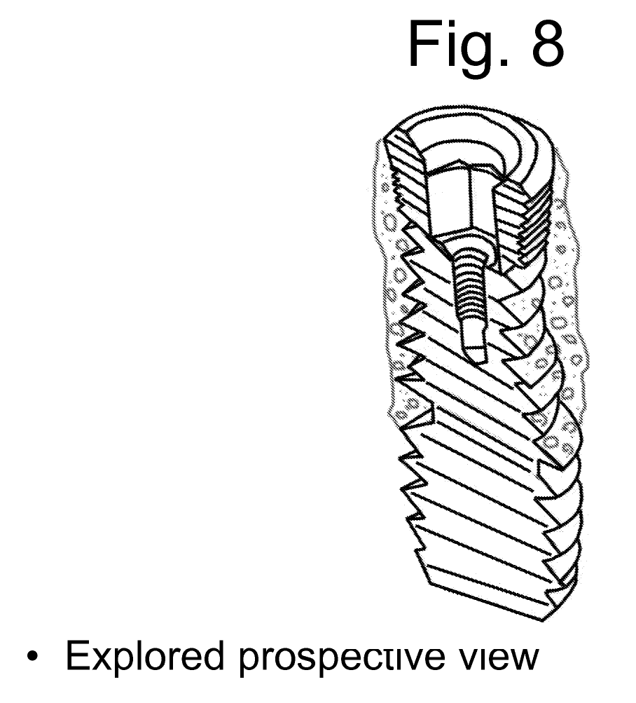

Referring to FIGS. 6 and 7, it shows the second embodiment of the present invention with two-piece design. It also has the neck constriction area (FIG. 8) like one-piece design as shown in FIG. 2. The neck constriction area is a circular, not helical, collar with at least 3 mm wide diameter and with a taper seating and a male connection screw 2 mm wide, connecting to the female connector located on the base root segment. This design allows the interchangeable ability in case needing different extension root segment of choice in some clinical situation.

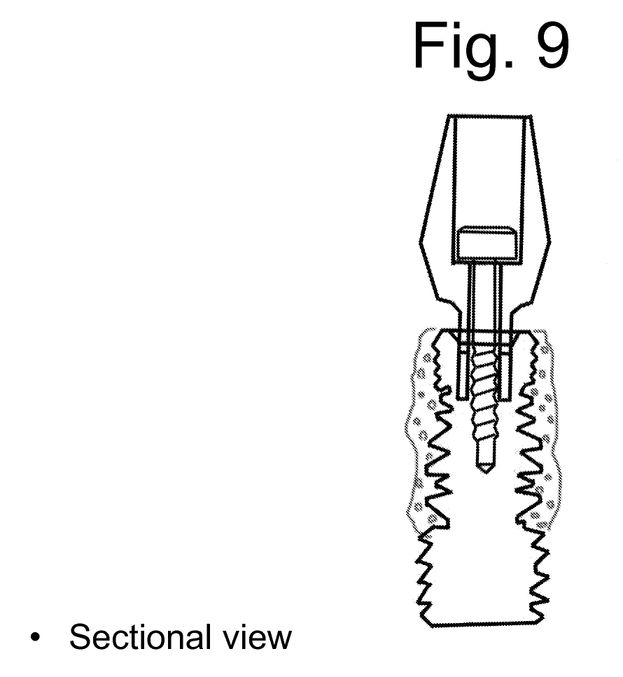

Referring to FIGS. 8 and 9, showing the third embodiment of the present invention, with collagen-coated surface treatment outside the course threaded surface on extension root segment which filled the upper extension segment and makes the whole root has an anchor base root and a resolvable portion on top root.

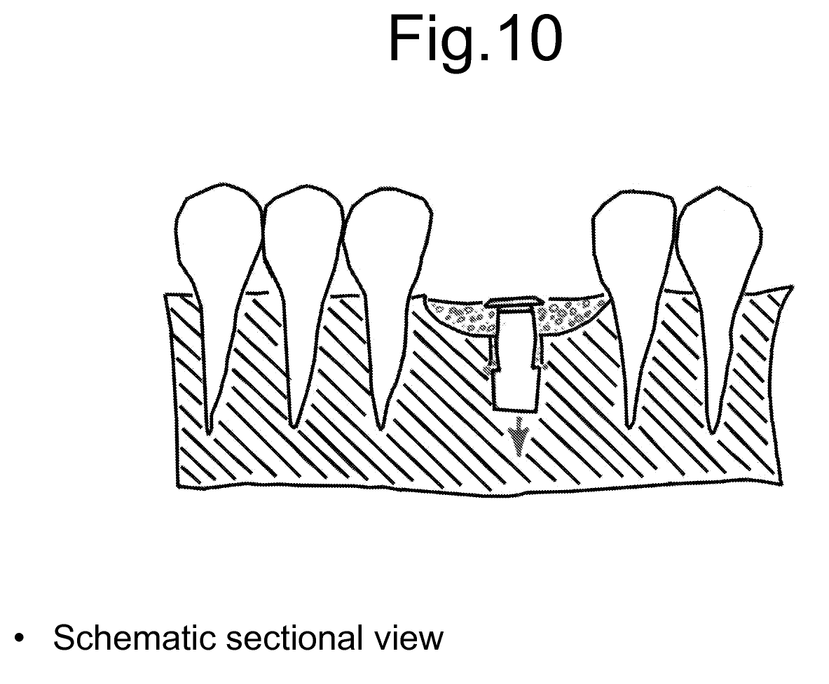

And referring to FIG. 10 it shows that in fast tooth implanting, an implant root 10 is directly implanted into a recess (R) on the denture base; by virtue that the coarse threaded portion 23 has the sharp blade 24 on the very bottom, it can easily cut in the bone to make the implant root 10 be correctly implanted vertically.

In conclusion, according to the description disclosed above, the improved implant root provided by the present invention has the novelty and improvement that a patent should have. And the embodiments given are only for illustrating the present invention; it will be apparent to those skilled in this art that various equivalent modifications or changes without departing from the spirit of this invention, such as increasing or shape changing of the treated surfaces, shall also fall within the scope of the appended claims.

1. a coarse threaded portion of the implant root is formed to have a wider base and to have a extension root with various radiant thread constructed, characterized with a circumferential constricted neck between these two segments. Both segments are designed to be seated into alveolar bone as implant root fixture. The widest diameter of the upper and lower segment is either equal or the lower base is slightly wider than lower segment for the most of it. The constricted neck in between the base and extension of the segments and the shape of the lower base segment allow the lower base implant root to serve as a primary stability anchor. Combining the concept of wilder base with extensions allow the base segment of the implant fixture becomes a physiological anchor healed in bone and to increase the stability of the implant around the implant fixture after bone heal thus advantage the implant to be placed in some type of bones needing this kind of anchorage.

2. The improved implant root for tooth implanting as claimed in claim 1, is one-piece construction.

3. The improved implant root for tooth implanting as claimed in claim 1, is two-piece construction and the extension and base roots are connected by male thread screw on top extension root and a female threaded hole on base root.

4. The improved implant root for tooth implanting as claimed in claim 1, the widest diameter of the upper extension root segment is located on the bottom threads close to neck constriction of two segments, preferably on the last two threads on extension root segment.

5. The improved implant root for tooth implanting as claimed in claim 1, the threads of smaller diameter extension is covered with bio-resolvable material, preferably collagen.

6. The improved implant root for tooth implanting as claimed in claim 1, wherein said top connecting portion of upper extension segment is provided with a polygonal hole, a screw hole is provided in a opposite surface of said polygonal hole, a polygonal shape of said polygonal hole is mated with a shape of a connecting section of said abutment of said crown, so that said abutment is fast and correctly positioned when in connecting with said implant root, and a bolt on a bottom of said abutment is adapted to being smoothly rotated to connect into said screw hole.

7. The improved implant root for tooth implanting as claimed in claim 1, wherein said at least two helical treated surfaces, preferring three helical treated surfaces, laid out in an equiangularly spaced away mode, said helical treated surfaces are formed on said coarse threaded portion and extending, in said vertical direction from said bottom end to said top end of said coarse threaded portion; and extending, in whole length of said coarse threaded portion of the base root till a fine threaded portion of said connecting portion on extension root, and are cut inwardly gradually shallower from bottom to top of the extension root, except the neck connection area.

8. The improved implant root for tooth implanting as claimed in claim 8, wherein each of many cut faces on said at least two helical treated surfaces at corresponding one of said threads forms a sharp blade at an intercrossing area with said thread of said coarse threaded portion.
